(19) United States
(12) Patent Application Publication
(10) Pub. No.: US 2020/0124828 A1
(43) Pub. Date: Apr. 23, 2020

(54) MOBILE TERMINAL

(71) Applicant: LG ELECTRONICS INC., Seoul (KR)

(72) Inventors: Byeongkil KANG, Seoul (KR); Hakhae KIM, Seoul (KR)

(73) Assignee: LG ELECTRONICS INC., Seoul (KR)

(21) Appl. No.: 16/605,276

(22) PCT Filed: Apr. 19, 2017
(86) PCT No.: PCT/KR2017/004205

§ 371 Date: Oct. 15, 2019

(51) Int. Cl. G02B 13/00; G02B 15/163; G02B 3/12; G02B 26/00; H04N 5/225; H04M 1/02

(52) U.S. Cl. CPC G02B 13/0045; G02B 15/163; H04M 1/0264; G02B 26/004; H04N 5/2254; G02B 3/12

(57) ABSTRACT

According to the present invention, a mobile terminal comprises a camera module comprising: first and second lens groups; a liquid lens unit disposed between the first and second lens groups and having a refractive index changed by a voltage; an image sensor for forming an image by using light which has passed through the first and second lens groups and the liquid lens unit; and a liquid lens control unit for controlling the voltage to be applied to the liquid lens unit, wherein, when the camera module is activated, a control unit transmits a control signal to the liquid lens control unit such that a specific voltage, causing the first and second lens groups and the liquid lens unit to have a preset focal distance, is applied and a display unit outputs an image acquired by the camera module having the specific focal distance.

### TECHNICAL FIELD

The present disclosure relates to a mobile terminal provided with a camera module having a liquid lens unit.

### BACKGROUND ART

Terminals may be divided into mobile/portable terminals and stationary terminals according to mobility. Also, the mobile terminals may be classified into handheld types and vehicle mount types according to whether or not a user can directly carry.

The terminal has various functions according to development of technologies. For example, a mobile terminal can be allowed to capture still images or moving images, play music or video files, play games, receive broadcast and the like, so as to be implemented as an integrated multimedia player. Efforts are ongoing to support and increase the functionality of terminals. Such efforts include software improvements, as well as changes and improvements in the structural components.

Recently, there are increasing needs for a mobile terminal with a high-performance or high-speed camera. As a result, research has been carried out to employ a higher speed camera module. As the mobile terminal becomes lighter and slimmer, a size of the camera module gets smaller accordingly. However, it is not easy to implement autofocus (AF) and optical image stabilization (OIS) functions though physical movement of a lens unit while satisfying such needs.

### DISCLOSURE

### Technical Problem

Therefore, an aspect of the present disclosure is to obviate the above-mentioned problem and other drawbacks, namely, to provide a mobile terminal equipped with a camera module having a liquid lens unit.

### Technical Solution

In order to achieve the aspect and other advantages and in accordance with the purpose of the present disclosure, as embodied and broadly described herein, there is provided a mobile terminal includes a terminal body, a camera module mounted on one surface of the terminal body and performing an image capturing function, a display unit mounted on the terminal body, and a controller configured to control the camera module. The camera module may include a first lens group and a second lens group, a liquid lens unit disposed between the first lens group and the second lens group and having a refractive index changed by a voltage, an image sensor forming an image using light which has passed through the first lens group, the second lens group, and the liquid lens unit, and a liquid lens controller configured to control a voltage applied to the liquid lens unit. The controller, when the camera module is activated, may transmit a control signal to the liquid lens controller for applying a specific voltage, which allows the first lens group, the second lens group, and the liquid lens unit to have a preset focal length. The display unit may output an image obtained by the camera module having the specific focal length.

In one embodiment, the camera module may further include a Power Management Integrated Circuits (PMIC) configured to control a supply of power. The PMIC may supply power to the image sensor after the preset focal length is achieved by the first lens group, the second lens group, and the liquid lens unit. Accordingly, a user may be provided to have a clear preview image in focus.

In one embodiment, the controller may control the liquid lens unit to have the preset focal length when a change in an angular velocity of a first range is detected by a first gyro sensor, while the image is being displayed on the display unit. Accordingly, a camera is controlled by distinguishing a change of capturing environment and shaking of a hand.

### Advantageous Effects

According to the present disclosure, a liquid lens unit has AF and OIS functions, and an image is output after adjusting the liquid lens unit, so that lenses have a preset focal length. Thus, a clear preview image can be provided to a user.

In addition, after a focal length is set, shaking of a hand and movement of a mobile terminal are distinguished, and a refractive index is changed accordingly. Thus, the refractive index can be adjusted as intended by the user.

### BRIEF DESCRIPTION OF THE DRAWINGS

FIGS. 1A and 1B are conceptual views illustrating one example of a mobile terminal according to the present disclosure, viewed from different directions.

FIG. 2A is an exploded view of a camera module according to one embodiment of the present disclosure.

FIG. 2B is a sectional view of the camera module of FIG. 2A.

FIG. 3 is a conceptual view illustrating a liquid lens.

FIGS. 4A to 4B are conceptual views illustrating a control method of a liquid lens.

FIG. 5A is a block diagram illustrating components of a camera module according to one embodiment of the present disclosure.

FIG. 5B is a flowchart illustrating a control method of a camera module according to one embodiment of the present disclosure.

FIG. 6A is a block diagram illustrating components of a camera module according to one embodiment.

FIG. 6B is a flowchart illustrating a control method of a camera module based on shaking.

FIG. 6C is a conceptual view illustrating the control method of FIG. 6B.

FIG. 7 is a conceptual view illustrating a liquid lens unit having a temperature sensor.

### MODES FOR CARRYING OUT THE PREFERRED EMBODIMENTS

Description will now be given in detail according to exemplary embodiments disclosed herein, with reference to the accompanying drawings. For the sake of brief description with reference to the drawings, the same or equivalent components may be provided with the same or similar reference numbers, and description thereof will not be repeated. In general, a suffix such as “module” and “unit” may be used to refer to elements or components. Use of such a suffix herein is merely intended to facilitate description of the specification, and the suffix itself is not intended to give any special meaning or function. In describing the present disclosure, if a detailed explanation for a related known function or construction is considered to unnecessarily divert the gist of the present disclosure, such explanation has been omitted but would be understood by those skilled in the art. The accompanying drawings are used to help easily understand the technical idea of the present disclosure and it should be understood that the idea of the present disclosure is not limited by the accompanying drawings. The idea of the present disclosure should be construed to extend to any alterations, equivalents and substitutes besides the accompanying drawings.

Mobile terminals presented herein may be implemented using a variety of different types of terminals. Examples of such terminals include cellular phones, smart phones, user equipment, laptop computers, digital broadcast terminals, personal digital assistants (PDAs), portable multimedia players (PMPs), navigators, portable computers (PCs), slate PCs, tablet PCs, ultra books, wearable devices (for example, smart watches, smart glasses, head mounted displays (HMDs)), and the like.

Mobile terminals presented herein may be implemented using a variety of different types of terminals. Examples of such terminals include cellular phones, smart phones, user equipment, laptop computers, digital broadcast terminals, personal digital assistants (PDAs), portable multimedia players (PMPs), navigators, portable computers (PCs), slate PCs, tablet PCs, ultra books, wearable devices (for example, smart watches, smart glasses, head mounted displays (HMDs)), and the like.

By way of non-limiting example only, further description will be made with reference to particular types of mobile terminals. However, such teachings apply equally to other types of terminals, such as those types noted above. In addition, these teachings may also be applied to stationary terminals such as digital TV, desktop computers, and the like.

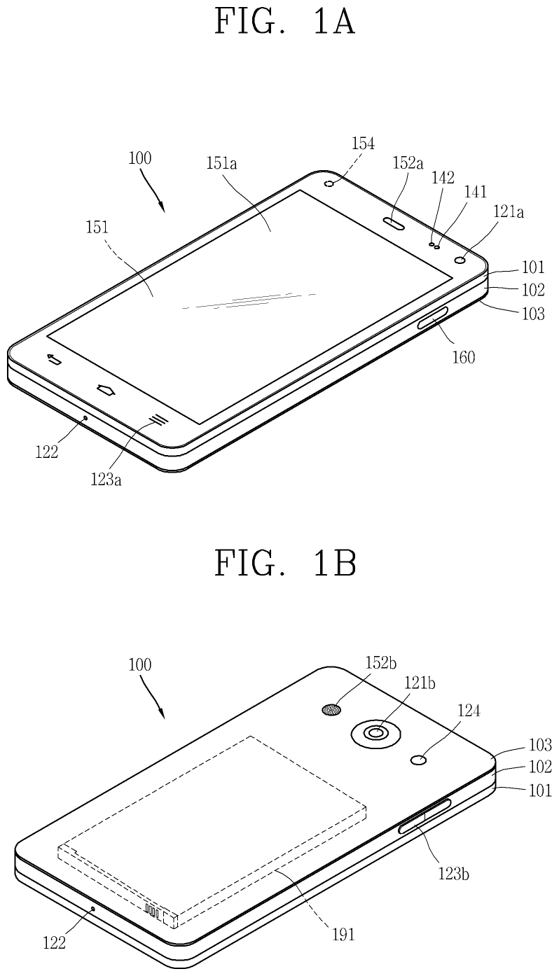

FIGS. 1A and 1B are conceptual views illustrating one example of a mobile terminal according to the present disclosure, viewed from different directions.

Referring to FIGS. 1A and 1B, the mobile terminal 100 includes a bar-like terminal body. However, the mobile terminal 100 may alternatively be implemented in any of a variety of different configurations. Examples of such configurations include watch type, clip-type, glasses-type, or a folder-type, flip-type, slide-type, swing-type, and swivel-type in which two and more bodies are combined with each other in a relatively movable manner, and combinations thereof. Discussion herein will often relate to a particular type of mobile terminal. However, such teachings with regard to a particular type of mobile terminal will generally apply to other types of mobile terminals as well.

Here, considering the mobile terminal 100 as at least one assembly, the terminal body may be understood as a conception referring to the assembly.

The mobile terminal 100 will generally include a case (for example, frame, housing, cover, and the like) forming the appearance of the terminal. In this embodiment, the case is formed using a front case 101 and a rear case 102. Various electronic components are interposed into a space formed between the front case 101 and the rear case 102. At least one rear case may be additionally positioned between the front case 101 and the rear case 102.

The display unit 151 is shown located on the front side of the terminal body to output information. As illustrated, a window 151a of the display unit 151 may be mounted to the front case 101 to form the front surface of the terminal body together with the front case 101.

In some embodiments, electronic components may also be mounted to the rear case 102. Examples of such electronic components include a detachable battery 191, an identification module, a memory card, and the like. In this case, a rear cover 103 is shown covering the electronic components, and this cover may be detachably coupled to the rear case 102. Therefore, when the rear cover 103 is detached from the rear case 102, the electronic components mounted on the rear case 102 are exposed to the outside.

As illustrated, when the rear cover 103 is coupled to the rear case 102, a side surface of the rear case 102 may partially be exposed. In some cases, upon the coupling, the rear case 102 may also be completely shielded by the rear cover 103. Meanwhile, the rear cover 103 may include an opening for externally exposing a camera 121b or an audio output module 152b.

The cases 101, 102, 103 may be formed by injection-molding synthetic resin or may be formed of a metal, for example, stainless steel (STS), aluminum (Al), titanium (Ti), or the like.

As an alternative to the example in which the plurality of cases forms an inner space for accommodating components, the mobile terminal 100 may be configured such that one case forms the inner space. In this case, a mobile terminal 100 having a uni-body is formed in such a manner that synthetic resin or metal extends from a side surface to a rear surface.

Meanwhile, the mobile terminal 100 may include a waterproofing unit (not shown) for preventing introduction of water into the terminal body. For example, the waterproofing unit may include a waterproofing member which is located between the window 151a and the front case 101, between the front case 101 and the rear case 102, or between the rear case 102 and the rear cover 103, to hermetically seal an inner space when those cases are coupled.

The mobile terminal 100 may include a display unit 151, first and second audio output module 152a and 152b, a proximity sensor 141, an illumination sensor 142, an optical output module 154, first and second cameras 121a and 121b, first and second manipulation units 123a and 123b, a microphone 122, an interface unit 160, and the like.

Hereinafter, as illustrated in FIGS. 1A and 1B, description will be given of the exemplary mobile terminal 100 in which the front surface of the terminal body is shown having the display unit 151, the first audio output module 152a, the proximity sensor 141, the illumination sensor 142, the optical output module 154, the first camera 121a, and the first manipulation unit 123a, the side surface of the terminal body is shown having the second manipulation unit 123b, the microphone 122, and the interface unit 160, and the rear surface of the terminal body is shown having the second audio output module 152b and the second camera 121b.

However, those components may not be limited to the arrangement. Some components may be omitted or rearranged or located on different surfaces. For example, the first manipulation unit 123a may be located on another surface of the terminal body, and the second audio output module 152b may be located on the side surface of the terminal body other than the rear surface of the terminal body.

The display unit 151 is generally configured to output information processed in the mobile terminal 100. For example, the display unit 151 may display execution screen information of an application program executing at the mobile terminal 100 or user interface (UI) and graphic user interface (GUI) information in response to the execution screen information.

The display module 151 may include at least one of a liquid crystal display (LCD), a thin film transistor-LCD (TFT LCD), an organic light-emitting diode (OLED), a flexible display, a three-dimensional (3D) display and an e-ink display.

The display unit 151 may be implemented using two display devices, according to the configuration type thereof. For instance, a plurality of the display units 151 may be arranged on one side, either spaced apart from each other, or these devices may be integrated, or these devices may be arranged on different surfaces.

The display unit 151 may include a touch sensor that senses a touch with respect to the display unit 151 so as to receive a control command in a touch manner. Accordingly, when a touch is applied to the display unit 151, the touch sensor may sense the touch, and a controller (or control unit) 180 may generate a control command corresponding to the touch. Contents input in the touch manner may be characters, numbers, instructions in various modes, or a menu item that can be specified.

On the other hand, the touch sensor may be configured in a form of a film having a touch pattern and disposed between a window 151a and a display (not illustrated) on a rear surface of the window, or may be a metal wire directly patterned on the rear surface of the window. Alternatively, the touch sensor may be formed integrally with the display. For example, the touch sensor may be disposed on a substrate of the display, or may be provided inside the display.

In this way, the display unit 151 may form a touch screen together with the touch sensor, and in this case, the touch screen may function as the user input unit (123, see FIG. 1A). In some cases, the touch screen may replace at least some of functions of a first manipulation unit 123a.

The first audio output module 152a may be implemented as a receiver for transmitting a call sound to a user's ear and the second audio output module 152b may be implemented as a loud speaker for outputting various alarm sounds or multimedia reproduction request sounds.

The window 151a of the display unit 151 may include a sound hole for emitting sounds generated from the first audio output module 152a. However, the present disclosure is not limited thereto, and the sounds may be released along an assembly gap between the structural bodies (for example, a gap between the window 151a and the front case 101). In this case, a hole independently formed to output audio sounds may not be seen or may otherwise be hidden in terms of appearance, thereby further simplifying the appearance of the mobile terminal 100.

The optical output module 154 may be configured to output light for indicating an event generation. Examples of such events may include a message reception, a call signal reception, a missed call, an alarm, a schedule alarm, an email reception, information reception through an application, and the like. When a user has checked a generated event, the controller 180 may control the optical output module 154 to stop the light output.

The first camera 121a may process image frames such as still or moving images obtained by the image sensor in a capture mode or a video call mode. The processed image frames can then be displayed on the display unit 151 or stored in the memory 170.

The first and second manipulation units 123a and 123b are examples of the user input unit 123, which may be manipulated by a user to provide input to the mobile terminal 100. The first and second manipulation units 123a and 123b may also be commonly referred to as a manipulating portion. The first and second manipulation units 123a and 123b may employ any method if it is a tactile manner allowing the user to perform manipulation with a tactile feeling such as touch, push, scroll or the like. The first and second manipulation units 123a and 123b may also be manipulated through a proximity touch, a hovering touch, and the like, without a user's tactile feeling.

The drawings are illustrated on the basis that the first manipulation unit 123a is a touch key, but the present disclosure may not be necessarily limited to this. For example, the first manipulation unit 123a may be configured with a mechanical key, or a combination of a touch key and a push key.

The content received by the first and second manipulation units 123a and 123b may be set in various ways. For example, the first manipulation unit 123a may be used by the user to input a command such as menu, home key, cancel, search, or the like, and the second manipulation unit 123b may be used by the user to input a command, such as controlling a volume level being output from the first or second audio output module 152a or 152b, switching into a touch recognition mode of the display unit 151, or the like.

On the other hand, as another example of the user input unit 123, a rear input unit (not shown) may be disposed on the rear surface of the terminal body. The rear input unit may be manipulated by a user to input a command for controlling an operation of the mobile terminal 100. The content input may be set in various ways. For example, the rear input unit may be used by the user to input a command, such as power on/off, start, end, scroll or the like, controlling a volume level being output from the first or second audio output module 152a or 152b, switching into a touch recognition mode of the display unit 151, or the like. The rear input unit may be implemented into a form allowing a touch input, a push input or a combination thereof.

The rear input unit may be disposed to overlap the display unit 151 of the front surface in a thickness direction of the terminal body. As one example, the rear input unit may be disposed on an upper end portion of the rear surface of the terminal body such that a user can easily manipulate it using a forefinger when the user grabs the terminal body with one hand. However, the present disclosure may not be limited to this, and the position of the rear input unit may be changeable.

When the rear input unit is disposed on the rear surface of the terminal body, a new user interface may be implemented using the rear input unit. Also, the aforementioned touch screen or the rear input unit may substitute for at least part of functions of the first manipulation unit 123a located on the front surface of the terminal body. Accordingly, when the first manipulation unit 123a is not disposed on the front surface of the terminal body, the display unit 151 may be implemented to have a larger screen.

On the other hand, the mobile terminal 100 may include a finger scan sensor which scans a user's fingerprint. The controller may use fingerprint information sensed by the finger scan sensor as an authentication means. The finger scan sensor may be installed in the display unit 151 or the user input unit 123.

The microphone 122 may be configured to receive the user's voice, other sounds, and the like. The microphone 122 may be provided at a plurality of places, and configured to receive stereo sounds.

The interface unit 160 may serve as a path allowing the mobile terminal 100 to interface with external devices. For example, the interface unit 160 may be at least one of a connection terminal for connecting to another device (for example, an earphone, an external speaker, or the like), a port for near field communication (for example, an Infrared DaAssociation (IrDA) port, a Bluetooth port, a wireless LAN port, and the like), or a power supply terminal for supplying power to the mobile terminal 100. The interface unit 160 may be implemented in the form of a socket for accommodating an external card, such as Subscriber Identification Module (SIM), User Identity Module (UIM), or a memory card for information storage.

A second display unit 251 is disposed on the rear surface of the terminal body according to the present disclosure. Accordingly, an additional rear camera and flash may not be disposed on the rear surface of the terminal body.

The second audio output module 152b may further be disposed on the rear surface of the terminal body. The second audio output module 152b may implement stereophonic sound functions in conjunction with the first audio output module 152a, and may be also used for implementing a speaker phone mode for call communication.

At least one antenna for wireless communication may be disposed on the terminal body. The antenna may be embedded in the terminal body or formed in the case. For example, an antenna which configures a part of the broadcast receiving module 111 (see FIG. 1A) may be retractable into the terminal body. Alternatively, an antenna may be formed in a form of film to be attached onto an inner surface of the rear cover 103 or a case including a conductive material may serve as an antenna.

The terminal body is provided with a power supply unit 190 (see FIG. 1A) for supplying power to the mobile terminal 100. The power supply unit 190 may include a batter 191 which is mounted in the terminal body or detachably coupled to an outside of the terminal body.

The battery 191 may receive power via a power cable connected to the interface unit 160. Also, the battery 191 may be (re)chargeable in a wireless manner using a wireless charger. The wireless charging may be implemented by magnetic induction or electromagnetic resonance.

On the other hand, the drawing illustrates that the rear cover 103 is coupled to the rear case 102 for shielding the battery 191, so as to prevent separation of the battery 191 and protect the battery 191 from an external impact or foreign materials. When the battery 191 is detachable from the terminal body, the rear case 103 may be detachably coupled to the rear case 102.

Hereinafter, embodiments related to a control method that can be implemented in a mobile terminal configured as above will be described with reference to the accompanying drawings. It will be apparent to those skilled in the art that the present disclosure may be embodied in other specific forms without departing from the spirit or essential characteristics thereof.

An accessory for protecting an appearance or assisting or extending the functions of the mobile terminal 100 may further be provided on the mobile terminal 100. As one example of the accessory, a cover or pouch for covering or accommodating at least one surface of the mobile terminal 100 may be provided. The cover or pouch may cooperate with the display unit 151 to extend the function of the mobile terminal 100. Another example of the accessory may be a touch pen for assisting or extending a touch input onto a touch screen.

A camera module according to the present disclosure includes a liquid lens unit changing a focal length (or distance) and having an image stabilization function. The controller 180 may change a refractive index by applying a voltage to the liquid lens unit while the camera module is activated.

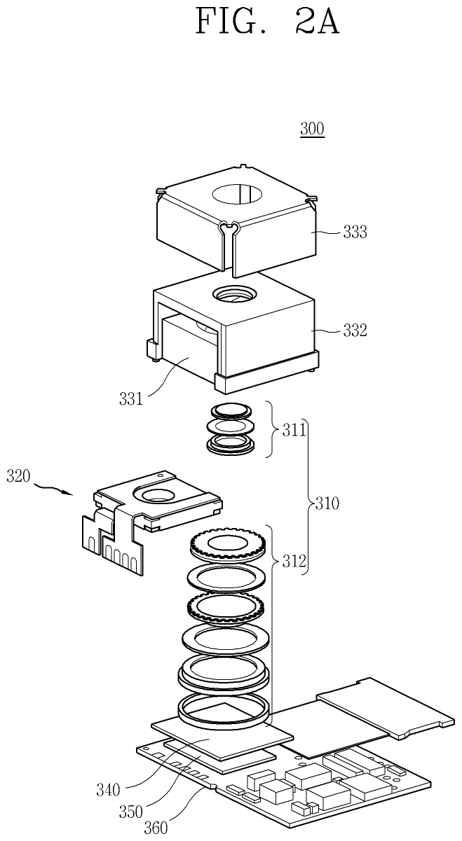

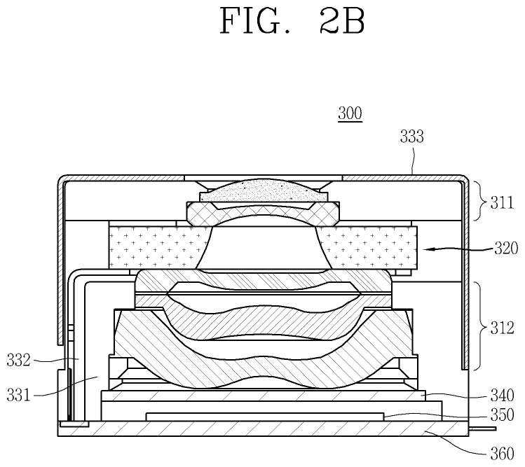

FIG. 2A is an exploded view of a camera module according to one embodiment of the present disclosure, and FIG. 2B is a sectional view of the camera module of FIG. 2A.

Referring to FIGS. 2A and 2B, a camera module 300 according to one embodiment of the present disclosure includes a lens unit 310 having a first lens group 311 and a second lens group 312, a liquid lens unit 320 disposed between the first lens group 311 and the second lens group 312, a first housing 331 in which the second lens group 312 is accommodated, a second housing 332 in which the lens unit 310 and the liquid lens unit 320 are accommodated, a shield can 333 covering the first and second housings 331 and 332, an IR filter 340, an image sensor 350, and a Printed Circuit Board (PCB) 360.

The first and second lens groups 311 and 312 include a plurality of lenses, respectively, different from one another, so as to form a preset focal length together with the liquid lens unit 320. The plurality of lenses included in the second lens group 312 is accommodated in the first housing 331 in a manner of being arranged with respect to an optical axis. The first housing 331 includes a through hole through which the optical axis passes. Part of the plurality of lenses of the second lens group 312 may be inserted into the through hole.

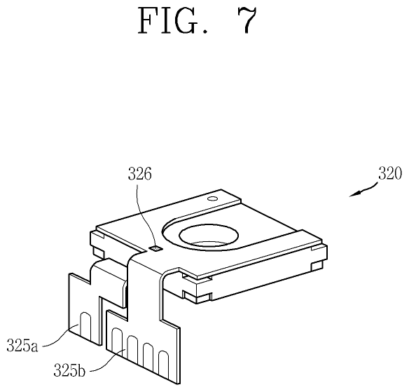

The liquid lens unit 320 is disposed on the first housing 331. The liquid lens unit 320 is made up of a first liquid and a second liquid covered by two PCBs and a base substrate (or window glass) (see FIG. 7), and is disposed such that a portion (or region) through which light passes is overlapped with the through hole of the first housing 331.

The plurality of lenses of the first lens group 311 is disposed on the liquid lens unit 320. The plurality of lenses of the first lens group 311 is arranged by the optical axis. One lens of the first lens group 311 may be disposed in a manner of being inserted into a through hole of the second housing 332.

The liquid lens unit 320 and the second lens group 312 are covered by the second housing 332, and the shield can 333 is formed to cover the second housing 332. The second housing 332, with the liquid lens unit 330 inserted therein, may include an opening so that a Flexible Printed Circuit Board (FPCB) of the liquid lens unit 320 is exposed to be electrically connected to the PCB 360.

The opening is covered by the shield can 333.

The IR filter 340 may correspond to an IR cut (or cut-off) filter that blocks IR light while passing other light received by the lens unit 310 and the liquid lens unit 320. The light which has passed through the IR cut-off filter 340 reaches the image sensor 350 to form an image.

Meanwhile, according to another embodiment, the liquid lens unit 320 may be disposed above the first and second lens groups 311 and 312. In this case, the first and second lens groups 311 and 312 may be accommodated in a barrel for moving the plurality of lenses of the first and second lens groups 311 and 312.

The camera module 300 according to this embodiment of the present disclosure adjusts a focal length and corrects shaking by controlling the liquid lens unit 320. Accordingly, a physical mechanical structure (lens barrel) for moving the plurality of lenses vertically or horizontally is unnecessary. Thus, weight of a camera module itself can be reduced and controlling speed of the camera module can be improved as physical movement is unnecessary. Hereinafter, a configuration and a control method of the liquid lens unit 320 will be described.

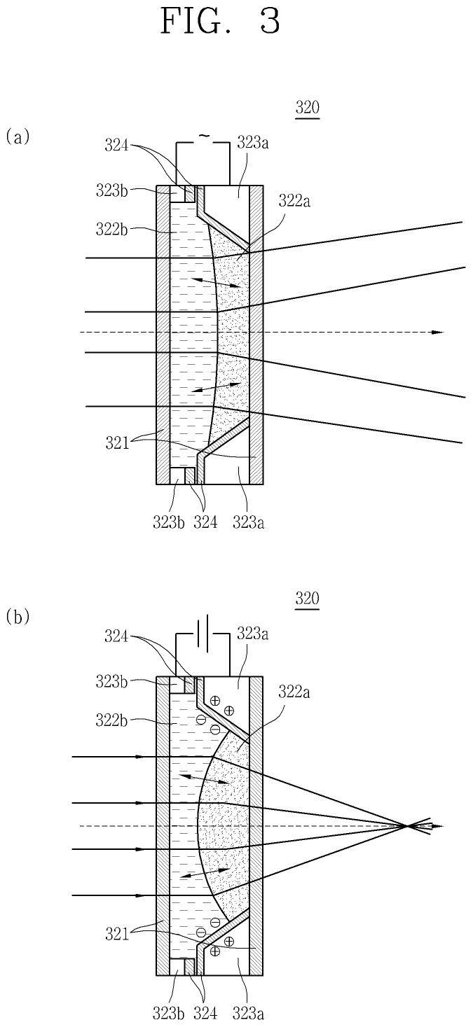

FIG. 3 is a conceptual view illustrating a liquid lens.

In the liquid lens (unit) 320 according to this embodiment of the present disclosure, interfacial (or surface) tension of conductive liquids is controlled by the conductive liquids with an insulator interposed therebetween and voltages generated. The liquid lens 320 includes a window 321, a first material 322a and a second material 322b accommodated in the window 321 in a non-mixed state, a first electrode portion 323a, a second electrode portion 323b, and an insulating portion 324 disposed between the first electrode portion 323a and the second electrode portion 323b. The first material 322a is made up of a conductive liquid in which an electric current flows, and the second material 322b is made up of of a non-conductive liquid in which no electric current flows.

When an electric current is supplied by the first and second electrode portions 323a and 323b, the first material 322a is convexly deformed. In this state, the liquid lens 320 is implemented as a convex lens, and thus a focal length is shortened, forming an image closer to the retina of the eye.

When no voltage is applied to the first and second electrode portions 323a and 323b, the first material 322a is flatly deformed. In this case, a refractive index (or index of refraction) is changed, thus light is refracted in a direction that the light spreads out. The mobile terminal 100 according to the present disclosure changes the refractive index of the liquid lens 320 to adjust the focal length, and refracts light in a desired direction by controlling the light to be refracted in the direction desired as it is shaken.

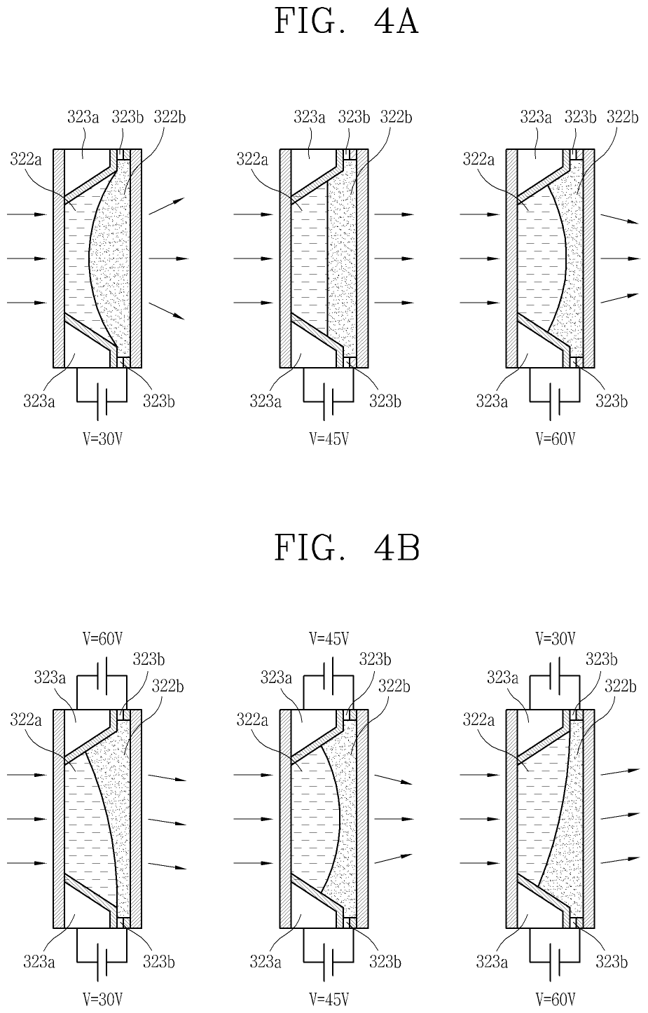

FIGS. 4A and 4B are conceptual views illustrating a control method of a liquid lens.

A control method for adjusting a focal length using a liquid lens will be described with reference to FIG. 4A. The controller 180 automatically adjusts a focal point (or focus) by applying a specific voltage to the liquid lens 320 to change a refractive index by deforming a shape of an interface between the first material 322a and the second material 322b, thereby performing an autofocus (AF) function, which automatically adjusts the focus. The AF function corresponds to a function that automatically adjusts the lens so that a subject being photographed or captured is in focus.

When a first voltage is applied to the liquid lens 320, the liquid lens 320 is deformed to have a refractive index that can spread light out. That is, the first material 322a is concavely deformed, so the interface between the first material 322a and the second material 322b is concavely formed. When a second voltage, higher than the first voltage, is applied, the interface between the first material 322a and the second material 322b may be formed to be flat. Here, the voltage is applied by any one of the first electrode portion 323a and the second electrode portion 323b, so as to adjust the focal length.

When a third voltage, higher than the second voltage, is applied, the first and second materials 322a and 322b are deformed to have a refractive index that can converge incident light. The first material 322a may be convexly deformed, so the interface between the first material 322a and the second material 322b may be convexly formed.

The controller 180 may adjust the focal length by changing a refractive index of the liquid lens 320 together with a refractive index of the first and second lens groups 311 and 312.

A control method for correcting shaking will be described with reference to FIG. 4B. The controller 180 may apply a different voltage to perform an Optical Image Stabilizer (01S) function according to movement (or flow) of liquids accommodated in the window 321.

When the controller 180 applies substantially the same voltage to the first and second electrode portions 323a and 323b, the interface between the first material 322a and the second material 322b is symmetrically formed with respect to the center of the window 321.

When a different voltage is applied to the first and second electrode portions 323a and 323b, the interface between the first material 322 and the second material 322b becomes asymmetric with respect to the center of the window 321. This is because the first material 322a is oriented in a direction to which a low voltage is applied. Accordingly, an angle of incident of light is changed, and a direction that light is refracted and is incident on the image sensor 350 is changed accordingly.

The controller 180 applies substantially the same voltage to the first and second electrode portions 323a and 323b in an initial state of the camera module 300 provided in the mobile terminal 100. When movement (or motion) is detected in the initial state, the controller 180 applies a different voltage to the first and second electrode portions 323a and 323b based on the movement.

Thereafter, the light incident on the camera module 300 is refracted at the interface between the first material 322a and the second material 322b, so as to precisely reach the image sensor 350.

In this case, the controller 180 maintains a refractive index of the center of the liquid lens 320. In more detail, an average value of voltage values applied to the first and second electrode portions 323a and 323b is controlled to be substantially the same as the voltage value applied in the initial state, so that a refractive index of the light incident on the center of the liquid lens 320 is the same. Accordingly, the camera module 300 can correct shaking while maintaining the initially set focal length.

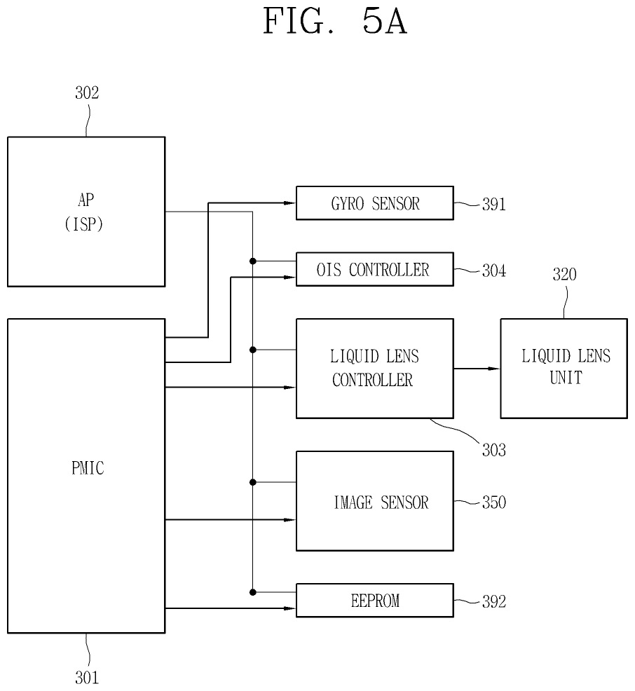

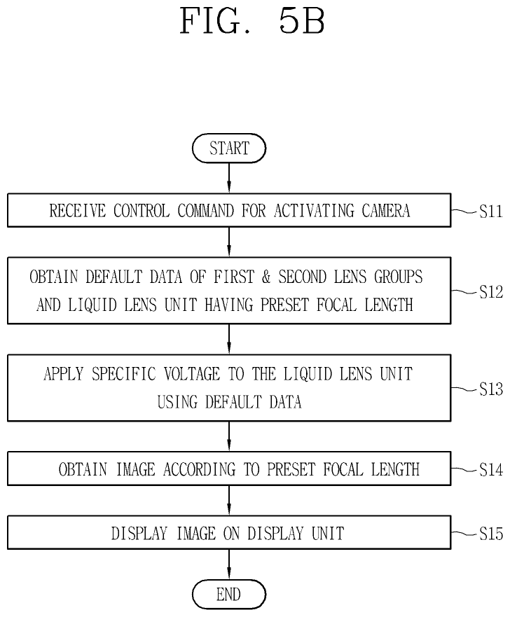

FIG. 5A is a block diagram illustrating components of a camera module according to one embodiment of the present disclosure, and FIG. 5B is a flowchart illustrating a control method of a camera module according to one embodiment of the present disclosure.

The camera module 300 includes an Application Processor (AP) 302 for controlling each of the components, and Power Management Integrated Circuits (PMIC) 301 for controlling power supply of each of the components. The camera module 300 also includes a liquid lens controller (or control unit) 303 for controlling the camera module 300 and the liquid lens 320, an Optical Image Stabilization (OIS) controller 304, the image sensor 350, a gyro sensor 391, and a memory (EEPROM) 392.

The controller 180 of the mobile terminal 100 receives a control command for activating a camera (S11). The control command may correspond to execution of an application for capturing an image and a video using the camera. The controller 180 controls the AP 302 and the PMIC 301 based on the control command.

In response to the control command, the PMIC 301 supplies power to the liquid lens controller 303 and the memory (EEPROM) 392.

The camera module 300 obtains default data of the first and second lens groups 311 and 312, and the liquid lens unit 320 having a preset focal length (S12). The AP 302 obtains a control value of the liquid lens unit 320 to have the preset focal length from data pre-stored in the memory (EEPROM) 392. The AP 302 does not activate the AF function and the OIS function before controlling the liquid lens unit 320.

The default data may include control information regarding a voltage for securing a focal length set to be suitable for a camera function of the mobile terminal 100 together with the first and second lens groups 311 and 312.

The AP 302 transmits the default data to the liquid lens controller 303, then the liquid lens controller 303 applies a specific voltage to the liquid lens unit 320 (S13). The refractive index of the liquid lens unit 320 is changed in response to the specific voltage applied, allowing the first and second lens groups 311 and 312, and the liquid lens unit 320 to have the preset focal length.

When it is adjusted to the preset focal length, the AP 302 controls the image sensor 350 to acquire an image (S14). The PMIC 301 supplies power to the image sensor 350, the gyro sensor 391 and the OIS controller 304, and the AP 302 activates the image sensor 350, the gyro sensor 391, and the OIS controller 304.

The obtained image is displayed on the display unit 151 as a preview image until a control command for capturing is applied (S15). In addition, the AF function and the OIS function are activated.

In other words, the camera module 300 preferentially controls the liquid lens unit 320 to have the preset initial focal length before the camera function is executed, and then controls the AF and OIS functions to be performed. Thus, the camera module can be controlled more stably since the liquid lens unit 320 is controlled based on shaking detected after the initial focus is fixed.

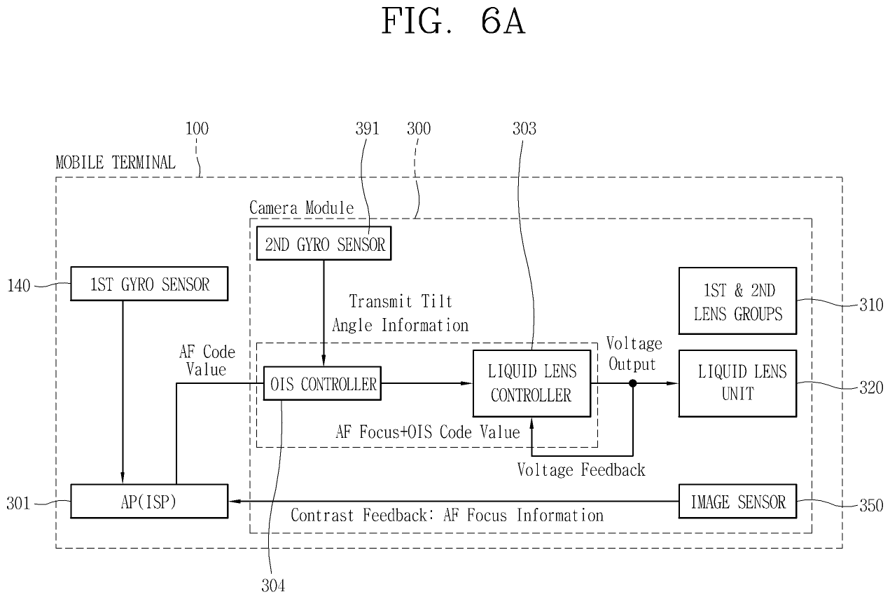

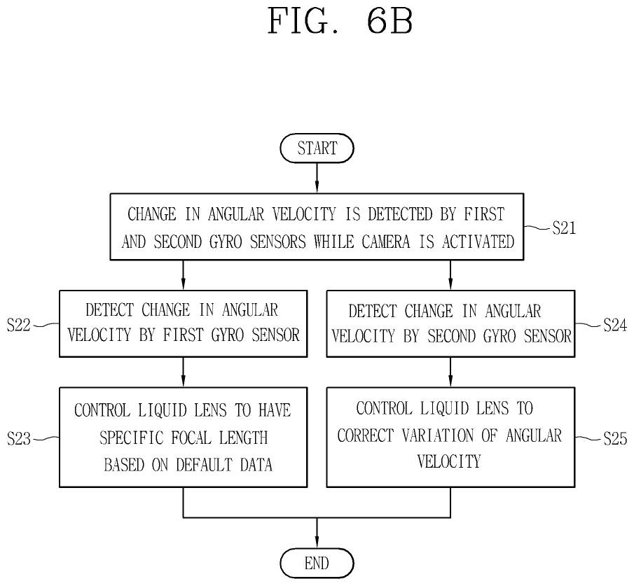

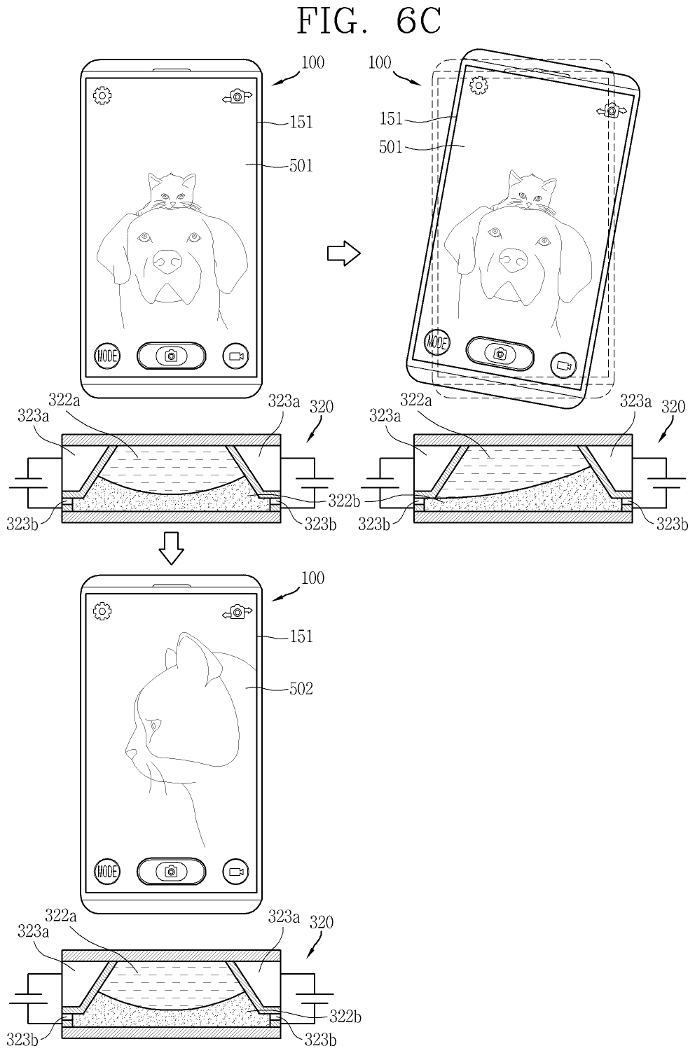

FIG. 6A is a block diagram illustrating components of a camera module according to one exemplary embodiment, FIG. 6B is a flowchart illustrating a control method of a camera module based on shaking, and FIG. 6C is a conceptual view illustrating the control method of FIG. 6B.

Referring to FIG. 6A, the mobile terminal 100 includes a first gyro sensor 140 and the AP 302 of the camera module 300. The AP 302 transmits an AF code value to the OIS controller 304. The AP 302 may generate the AF code value based on a motion or movement detected by the first gyro sensor 140.

Meanwhile, the camera module 300 includes a second gyro sensor 391. The first and second gyro sensors 140 and 391 detect an angular velocity and a rational motion of different ranges. The first gyro sensor 140 detects a relatively large rotation, and the second gyro sensor 391 detects a relatively small rotation (vibration). The second gyro sensor 391 is configured to measure a low angular velocity for detecting hand shake.

The OIS controller 304 obtains tilting information detected by the second gyro sensor 391. Here, the tilting information may include real-time angle variation information generated by rotation while the camera module 300 is activated. The OIS controller 304 transmits the AF code value received from the AP 302 and a control signal using the tilting information to the liquid lens controller 303. The liquid lens controller 303 controls the liquid lens unit 320 to apply a voltage using the control signal.

The liquid lens unit 320 outputs the voltage applied by the control signal, and transfers the corresponding AF information back to the liquid lens controller 303. AF information on whether contrast is maximized while deforming the interface between the first material 322a and the second material 322b of the liquid lens unit 320 by the voltage is generated. The liquid lens controller 303 may reset a voltage value applied using the AF information.

Meanwhile, the image sensor 350 may form an image using light received by the liquid lens unit 320 and the lens unit 310, and transmit AF information included in the image to the AP 302. The AP 302 may transmit a control signal to the OIS controller 304 for adjusting the focal length using the AF information.

In the camera module 300 according to the present disclosure, the liquid lens unit 320 provides AF information before an image is formed by the image sensor 350, thereby correcting the focus more quickly by readjusting a voltage applied.

In addition, the mobile terminal 100 may further activate a Laser Detect Auto-Focus (LDAF) function and/or a Phase Detection Auto-Focus (PDAF) function to correct the focus.

In this case, the AP 302 controls the liquid lens unit 320 to perform primary focusing so as to focus a distance initially measured through the LDAF and/or PDAF. Thereafter, the liquid lens unit 320 may be controlled to perform second focusing through the contrast of an image formed by the image sensor 350 based on the initially measured distance.

A method for controlling the camera module 300 when shaken will be described with reference to FIGS. 6B and 6C.

Referring to FIGS. 6B and 6C, the first and second gyro sensors 140 and 391 detect a change in angular velocity of different ranges while the camera module 300 is activated (S21). The display unit 151 outputs a first preview image 501 captured based on the initial focal length of the camera module 300.

When the change in the angular velocity is detected by the first gyro sensor 140 (S22), the liquid lens unit 320 is controlled to have a specific focal length based on the default data (see FIG. 5B). When the angular velocity is detected by the first gyro sensor 140, the controller 180 determines that a user changes an area (or region) to be photographed as the mobile terminal 100 is moved. In other words, the display unit 151 outputs a second preview image 502 of another external environment captured. Accordingly, the camera module 300 readjusts the focal length to an initial (or default) value.

On the other hand, when the change in the angular velocity is detected by the second gyro sensor 391 (S24), this indicates shaking of a hand during image shooting. In this case, the display unit 151 may continuously display the first preview image 501, however, the image obtained may be minutely or slightly changed caused by shaking. Accordingly, the OIS controller 304 controls the liquid lens controller 303 to apply a specific voltage to the liquid lens unit 320. The OIS controller 304 changes a voltage applied to the liquid lens unit 320 in real time through an angular velocity detected by the second gyro sensor 391 in real time to perform the OIS function.

Thus, the camera module 300 can adjust the focal length by distinguishing movement of the mobile terminal itself and shaking of a hand.

FIG. 7 is a conceptual view of a liquid lens unit having a temperature sensor.

Referring to FIG. 7, the liquid lens unit 320 is provided with a window formed on both surfaces thereof, and includes a first FPCB 325a and a second FPCB 325b electrically connected to electrode portions. The first and second FPCBs 325a and 325b are electrically connected to a PCB to transmit and receive control signals.

Meanwhile, the liquid lens unit 320 includes a temperature sensor 326 mounted on one of the first FPCB 325a and the second FPCB 325b. In the drawing, the temperature sensor 326 is disposed on the second FPCB 325b and is exposed to outside of the liquid lens unit 320. In this case, an accommodating space for accommodating a portion (or region) in which the temperature sensor 326 is disposed is formed in the camera module 300.

Alternatively, the temperature sensor 326 may be disposed between the second FPCB 325b and the window. In this case, one region of the window is recessed to dispose the temperature sensor 326.

It is preferable that the temperature sensor 326 is disposed adjacent to the first and second materials 322a and 322b.

The controller 180 adjusts a voltage applied to the liquid lens unit 320 by using changes in temperature detected by the temperature sensor 326. When the external temperature changes, an interface between the first material 322a and the second material 322b of the liquid lens unit 320 is deformed. Accordingly, the controller 180 controls the voltage applied so that a shape of the interface is constantly maintained even when ambient temperature changes. Thus, it can be controlled to have a constant refractive index even when temperature is changed by heat generated inside the mobile terminal 100.

The present disclosure can be implemented as computer-readable codes in a program-recorded medium. The computer-readable medium may include all types of recording devices each storing data readable by a computer system. Examples of such computer-readable media may include hard disk drive (HDD), solid state disk (SSD), silicon disk drive (SDD), ROM, RAM, CD-ROM, magnetic tape, floppy disk, optical data storage element and the like. Also, the computer-readable medium may also be implemented as a format of carrier wave (e.g., transmission via an Internet). The computer may include the controller 180 of the terminal. Therefore, it should also be understood that the above-described embodiments are not limited by any of the details of the foregoing description, unless otherwise specified, but rather should be construed broadly within its scope as defined in the appended claims, and therefore all changes and modifications that fall within the metes and bounds of the claims, or equivalents of such metes and bounds are therefore intended to be embraced by the appended claims.

### INDUSTRIAL AVAILABILITY

The present disclosure relates to a mobile terminal having a camera that implements focus and image stabilization functions using a liquid lens unit, and thus it may be used in the relevant industrial fields.

1. A mobile terminal, comprising:
a terminal body;
a camera module mounted on one surface of the terminal body and performing an image capturing function;
a display unit mounted on the terminal body; and
a controller configured to control the camera module,
wherein the camera module comprises:
a first lens group and a second lens group;
a liquid lens unit disposed between the first lens group and the second lens group, and having a refractive index changed by a voltage;
an image sensor forming an image using light which has passed through the first lens group, the second lens group, and the liquid lens unit; and
a liquid lens controller configured to control a voltage applied to the liquid lens unit;
wherein the controller, when the camera module is activated, transmits a control signal to the liquid lens controller for applying a specific voltage, which allows the first lens group, the second lens group, and the liquid lens unit to have a preset focal length, and
wherein the display unit outputs an image obtained by the camera module having the specific focal length.

2. The mobile terminal of claim 1, further comprises a Power Management Integrated Circuits (PMIC) configured to control a supply of power,
wherein the PMIC supplies power to the image sensor after the preset focal length is achieved by the first lens group, the second lens group, and the liquid lens unit.

3. The mobile terminal of claim 1, wherein the camera module further comprises a memory configured to store default data for having the preset focal length.

4. The mobile terminal of claim 1, further comprises a first gyro sensor for sensing an angular velocity within a first range of movement of the terminal body,
wherein the camera module includes a second gyro sensor for sensing an angular velocity within a second range, and
wherein the controller controls the liquid lens controller so that a voltage applied to the liquid lens unit is adjusted based on an angular velocity detected by at least one of the first gyro sensor and the second gyro sensor.

5. The mobile terminal of claim 4, wherein the controller, after the preset focal length is achieved, controls the liquid lens controller so that a voltage is applied to the liquid lens unit based on the angular velocity.

6. The mobile terminal of claim 5, wherein the liquid lens unit includes a first material and a second material which do not mix with each other, and a first electrode portion and a second electrode portion that apply the voltage, and
wherein a different voltage is applied to the first electrode portion and the second electrode portion based on the angular velocity.

7. The mobile terminal of claim 4, wherein the controller controls the liquid lens unit to have the preset focal length when a change in the angular velocity of the first range is detected by the first gyro sensor, while the image is being displayed on the display unit.

8. The mobile terminal of claim 6, wherein the controller changes the voltage by receiving tilting information from the second gyro sensor when a change in the angular velocity of the second range is detected by the second gyro sensor, while the image is being displayed on the display unit.

9. The mobile terminal of claim 1, wherein the liquid lens controller receives autofocus (AF) information from the liquid lens unit to determine whether contrast is maximized, and changes a voltage to be applied based on the AF information.

10. The mobile terminal of claim 1, wherein the liquid lens unit further comprises a temperature sensor for detecting a temperature change.
